(19) United States
(12) Patent Application Publication
(10) Pub. No.: US 2023/0169517 A1
(43) Pub. Date: Jun. 1, 2023

(54) COMPLIANCE MODEL UTILIZING DISTRIBUTED LEDGER TECHNOLOGY

(71) Applicant: Wells Fargo Bank, N.A., San Francisco, CA (US)

(72) Inventors: Andrew J. Garner, IV, State Road, NC (US); Duc M. Trinh, Golden Valley, MN (US); Matthew Mullin Shepherd, Charlotte, NC (US)

(21) Appl. No.: 16/910,704

(22) Filed: Jun. 24, 2020

(51) Int. Cl. G06Q 30/00; G06F 16/23; G06Q 40/02

(52) U.S. Cl. CPC G06Q 30/018; G06F 16/2365; G06Q 40/02

(57) ABSTRACT

Systems, methods and computer-readable storage media utilized to verify data for a compliance model on a distributed ledger network. One method includes receiving, by one or more processing circuits, a compliance request associated with a compliance event. The method further includes aggregating, by the one or more processing circuits, compliance data associated with the compliance event and stored on the distributed ledger network. The method further includes analyzing, by the one or more processing circuits, the compliance data, wherein analyzing the compliance data comprises identifying a corrective action based on the compliance data and executing a first smart contract on the distributed ledger network and in response to successfully identifying the corrective action, executing, on the distributed ledger network, a second smart contract associated with the corrective action, wherein executing the second smart contract comprises updating the compliance data to include the corrective action.

### BACKGROUND

The present disclosure relates generally to the field of distributed ledger technology (DLT), and more particularly, in a computer networked environment in which parties execute agreements on distributed ledger networks.

### SUMMARY

Some arrangements relate to a method of data verification for a compliance model on a distributed ledger network, the method implemented by one or more processing circuits. The method includes receiving a compliance request associated with a compliance event, the compliance request comprises account information of a customer of a provider institution. Further, the method includes aggregating compliance data associated with the compliance event and stored on the distributed ledger network. Further, the method includes analyzing the compliance data, wherein analyzing the compliance data comprises identifying a corrective action based on the compliance data and executing a first smart contract on the distributed ledger network and in response to successfully identifying the corrective action, executing, on the distributed ledger network, a second smart contract associated with the corrective action, wherein executing the second smart contract comprises updating the compliance data to include the corrective action.

In some arrangements, in response to the second smart contract executing successfully the method further includes analyzing the compliance data, wherein analyzing the compliance data comprises identifying a second corrective action based on the compliance data and executing a third smart contract on the distributed ledger network. In various arrangements, in response to unsuccessfully identifying the second corrective action the method further includes processing the compliance event, wherein processing the compliance event comprises generating a blockchain block based on the compliance data and storing the blockchain block on the distributed ledger network and sending, to a user computing device, a compliance event notification including the compliance data, wherein the user computing device is associated with the customer of the provider institution. In some arrangements, in response to successfully identifying the second corrective action executing, on the distributed ledger network, a fourth smart contract associated with the second corrective action, wherein executing the fourth smart contract comprises updating the compliance data to include the second corrective action. In various arrangements, wherein each of the corrective action and the second corrective action comprises updating the compliance data to include the corrective action. In some arrangements, the compliance event is associated with a plurality of compliance parameters, and wherein the corrective action is associated with a discrepancy in the compliance data based on the plurality of compliance parameters. In various arrangements, the plurality of compliance parameters comprise timeline data associated with a plurality of time requirements. In some arrangements, executing the second smart contract on the distributed ledger network comprises fixing the discrepancy in the compliance data. In various arrangements, the method further includes generating, a blockchain block, the blockchain block comprises identifying the compliance data that included the discrepancy and modifying the compliance data to fix the discrepancy and storing the blockchain block on the distributed ledger network. In some arrangements, the distributed ledger network contains a plurality of nodes, and wherein the one or more processing circuits is a node on the distributed ledger network, and wherein the compliance request is associated with a financial agreement between the customer and the provider institution. In various arrangements, the compliance data comprises at least one of financial institution data, customer data, or agreement data, and wherein the financial institution data comprises at least one of token information, exchange histories, account balances, or verification information, and wherein the customer data comprises at least one of personal information, account number, credit card number, biometric data, social media data, geographic data, or unique identifier, and wherein the agreement data comprises at least one of a type of agreement, an agreement amount, one or more signer information, or one or more dates of signage. In some arrangements, each of the first smart contract and the second smart contract comprises smart contract code, the smart contract code associated with predefined rules that when executed performs a plurality of actions on the distributed ledger network, and wherein the predefined rules are associated with a plurality of time requirements. In various arrangements, the predefined rules further comprise associating one action of the plurality of actions to a plurality of corrective actions on the distributed ledger network.

Some arrangements relate to a system with at least one processing circuit. The at least one processing circuit can be configured to receive a compliance request associated with a compliance event, the compliance request comprises account information of a customer of a provider institution. Further, the at least one processing circuit can be configured to aggregate compliance data associated with the compliance event and stored on a distributed ledger network. Further, the at least one processing circuit can be configured to analyze the compliance data, wherein analyzing the compliance data comprises identifying a corrective action based on the compliance data and executing a first smart contract on the distributed ledger network and in response to successfully identifying the corrective action, execute, on the distributed ledger network, a second smart contract associated with the corrective action, wherein executing the second smart contract comprises updating the compliance data to include the corrective action.

In some arrangements, in response to unsuccessfully identifying the corrective action, the at least one processing circuit can be configured to process, by the one or more processing circuits, the compliance event, wherein processing the compliance event comprises generating a blockchain block based on the compliance data and storing the blockchain block on the distributed ledger network and send, to a user computing device, a compliance event notification including the compliance data, wherein the user computing device is associated with the customer of the provider institution. In various arrangements, the compliance event is associated with a plurality of compliance parameters, and wherein the corrective action is associated with a discrepancy in the compliance data based on the plurality of compliance parameters. In some arrangements, the plurality of compliance parameters comprise timeline data associated with a plurality of time requirements, and wherein executing the second smart contract on the distributed ledger network comprises fixing the discrepancy in the compliance data. In various arrangements, the at least one processing circuit can be configured to generate a blockchain block, the blockchain block comprises identifying the compliance data that included the discrepancy and modifying the compliance data to fix the discrepancy and store the blockchain block on the distributed ledger network. In some arrangements, the distributed ledger network contains a plurality of nodes, and wherein the one or more processing circuits is a node on the distributed ledger network, and wherein the compliance request is associated with a financial agreement between the customer and the provider institution.

Some arrangements relate to one or more computer-readable storage media having instructions stored thereon that, when executed by at least one processing circuit, cause the at least one processing circuit to receive a compliance request associated with a compliance event, the compliance request comprises account information of a customer of a provider institution. Further, the one or more computer-readable storage media having instructions stored thereon that, when executed by at least one processing circuit, cause the at least one processing circuit to aggregate compliance data associated with the compliance event and stored on a distributed ledger network. Further, the one or more computer-readable storage media having instructions stored thereon that, when executed by at least one processing circuit, cause the at least one processing circuit to analyze the compliance data, wherein analyzing the compliance data comprises identifying a corrective action based on the compliance data and executing a first smart contract on the distributed ledger network and in response to successfully identifying the corrective action, execute, on the distributed ledger network, a second smart contract associated with the corrective action, wherein executing the second smart contract comprises updating the compliance data to include the corrective action.

### BRIEF DESCRIPTION OF THE DRAWINGS

FIG. 1 is a block diagram depicting an example of an analysis system and associated environment, according to some arrangements;

FIG. 2 is a block diagram depicting an example of an analysis system node and associated environment, according to some arrangements;

FIG. 3A is a block diagram depicting an example of a distributed ledger node, according to some arrangements;

FIG. 3B is a block diagram depicting an example of a distributed ledger node, according to some arrangements;

FIG. 4 is a flowchart for a method of data verification for compliance models on a distributed ledger network, according to some arrangements;

FIG. 5A-5C example illustrations of compliance models utilizing timing, according to some arrangements;

FIG. 6 is an example illustration of compliance models utilizing mapping, according to some arrangements; and

FIG. 7 is a block diagram illustrating an example computing system suitable for use in the various arrangements described herein.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

Referring generally to the FIGS., the systems and methods disclosed herein relate generally to data verification for a compliance model on a distributed ledger network. In some arrangements, the causal compliance model can include analyzing compliance data associated with compliance events stored on a distributed ledger network. In general, compliance events can occur on the distributed ledger network that can be linked to a type of compliance check. The compliance check can trigger and/or execute appropriate smart contracts including analyzing the compliance data. In some arrangement, a corrective action can be identified, and another smart contract may be executed. The multi-tiered causal compliance model can utilize reporting and alerting throughout each process executed on and/or off the distributed ledger network.

In many systems, agreements (e.g., party agreements, transaction agreements, contracts) are executed and compliance events are recorded in a database. Each agreement may include a plurality of compliance events (e.g., signatures, credit check, state and federal regulation checks, co-signer, interest rate determination, contract term generation/modification, and so on), where each compliance event can have a particular set of parameters associated with the compliance event. Compliance models can be utilized to check the accuracy and completeness of compliance events such that each agreement is proper. Indeed, compliance models provide institutions and parties associated with the agreements an independent analysis of each agreement (e.g., each compliance event associated with each agreement) such that compliance events can be verified, and agreements can be guaranteed to be proper. However, the ability to have immutable data of compliance history on a distributed ledger network and execute real-time compliance checks on compliance events, such as executing smart contracts to perform validation of agreements in real-time, provides the compliance models with enhanced performance of a compliance model, enhanced traceability throughout the lifecycle of agreements, and enhanced efficiency due to providing real-time validation, while reducing inaccurate and/or improper information in agreements. This approach allows compliance models to maintain real-time accurate verified information, and a complete immutable history of agreements while providing efficient models that minimize inaccurate, lost/deleted, and/or altered information such that overall design of compliance models is improved. Therefore, aspect of the present disclosure improves compliance models by designing a compliance model that utilizes a distributed ledger network and smart contracts to execute accurate compliance checks on agreements. Furthermore, aspects of the present disclosure provide an improved external audit view of immutable data of compliance history performed in real-time. For example, independent third parties given access to the ledger can continuously and periodically (e.g., every 1 nanosecond, every 1 millisecond, every 1 second, every 1 minute, every 1 hour, every day, and so on) scan for one or more particular compliance events such that independent third parties given access to the ledger can generate statistics about compliance events from information stored on the distributed ledger.

Accordingly, the present disclosure is directed to systems and methods of data verification for a compliance model on a distributed ledger network. In some arrangements, the described systems and methods involve utilizing one or more processing circuits. The one or more processing circuits allow receiving of compliance requests that include account information of a customer of a provider institution. The one or more processing circuits can then aggregate and analyze compliance data to identify one or more corrective actions. One or more smart contracts on a distributed ledger network can be executed to fix corrective actions. In the present disclosure, the compliance data is associated with one or more compliance events of one or more agreements.

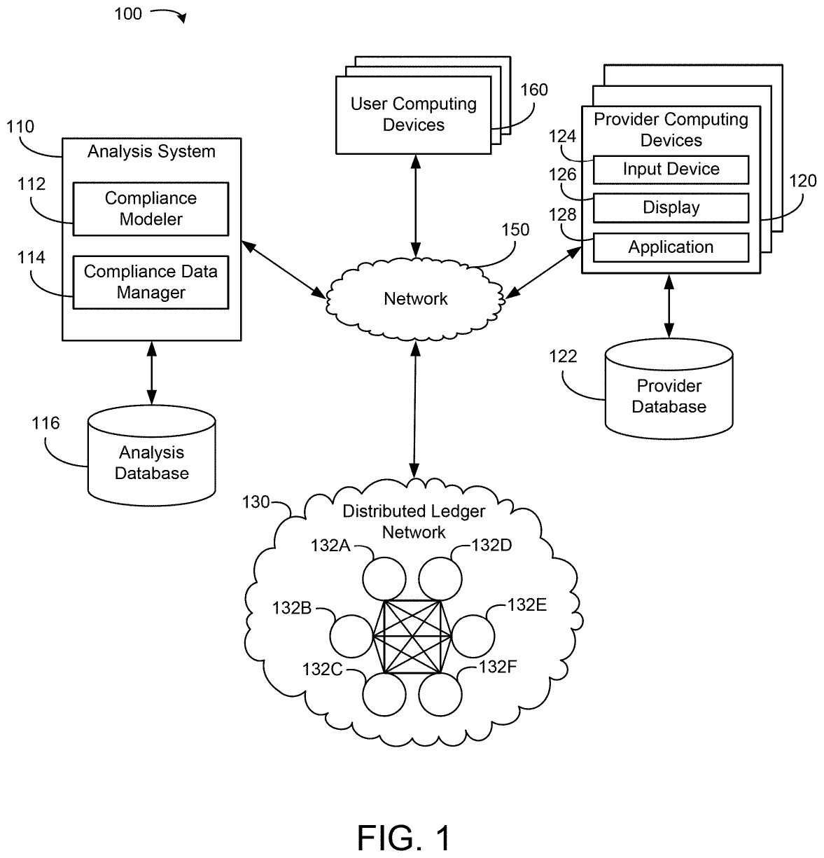

Referring now to FIG. 1, a block diagram depicting an example of an analysis system 110 and an associated environment 100 is shown, according to some arrangements. Referring to FIG. 1, the analysis system 110 is shown to include a compliance modeler 112, a compliance data manager 114, and an analysis database 116. The associated environment 100 is shown to include one or more provider computing devices 120, a provider database 122, a distributed ledger network 130, a plurality of distributed ledger nodes (e.g., distributed ledger nodes 132A, 132B, 132C, 132D, 132E, 132F), a network 150, and one or more user devices 160. Referring to FIGS. 1, 2, 3A, and 3B, the one or more processing circuits can include a microprocessor, an application specific integrated circuit (ASIC), a field-programmable gate array (FPGA), and so on, or combinations thereof. A memory can include, but is not limited to, electronic, optical, magnetic, or any other storage or transmission device capable of providing processor with program instructions. Instructions can include code from any suitable computer programming language.

One or more provider computing devices 120 may be used by a provider to perform various actions and/or access various types of data, some of which may be provided over a network 150 (e.g., the Internet, LAN, WAN, and so on). A “provider” used herein may refer to an individual operating one or more provider computing devices 120, and interacting with resources or data via the provider computing devices 120, and so on The provider computing devices 120 may be used to send data to the user devices 160, analysis system 110, used to access websites (e.g., using an internet browser), agreement information, and/or any other types of data. One or more user devices 160 (e.g., smartphones, tablets, computers, and so on) may be used by a user to perform various actions and/or access various types of content, some of which may be provided over the network 150. A “user” or “entity” used herein may refer to an individual operating one or more user devices 160, interacting with resources or data via the user devices 160, and so on. The user devices 160 may be used to send data to the provider computing devices 120, analysis system 110, and/or may be used to access websites (e.g., using an internet browser), agreement information, and/or any other types of data. In some implementations, the user devices 160 have enabled location services which can be tracked over network 150. Locations services may use a global positioning system (GPS) or other technologies to determine a location of user devices 160.

The network 150 may include a local area network (LAN), wide area network (WAN), a telephone network, such as the Public Switched Telephone Network (PSTN), a wireless link, an intranet, the Internet, or combinations thereof. The analysis system 110 and associated environment 100 can also include at least one data processing system or processing circuit, such as provider computing devices 120 and/or analysis system 110. The analysis system 110 can communicate via the network 150, for example with provider computing devices 120, user devices 160, and/or with the distributed ledger nodes 132A, 132B, 132C, 132D, 132E, 132F on the distributed ledger network 130.

In various arrangements, provider computing devices 120 can be communicably and operatively coupled (e.g., over network 150) to distributed ledger network 130 and/or analysis system 110. The provider computing devices 120 can be configured to query the distributed ledger network 130 for information and store information in the distributed ledger network 130. In various arrangements, the distributed ledger network 130 includes various transitory and/or non-transitory storage mediums (e.g., the storage mediums may include but are not limited to magnetic storage, optical storage, flash storage, RAM, and so on). In some arrangements, there may be a plurality of distributed ledger networks that are communicably coupled to each other such that each node on each distributed ledger network can communicate with each other over network 150.

Provider computing devices 120 can be configured to communicate with any device or system shown in environment 100 via the network 150. In some arrangements, the provider computing devices 120 can operate as an agreement device such that each provider computing device can execute agreements between parties. The provider computing devices 120 can include a display 126, an input device 124, and an application 128. The display 126 may be used to present account information, agreement information, and the like to a client. The input device 124 may be used to provide input to the provider computing devices 120 and to the analysis system 110 through the network 150.

The input may relate to a financial institution service (e.g., loan request, credit requests, personal information) used to facilitate agreements between the two parties (e.g., financial institution and a customer). The input device 124 may include a keyboard, a mouse, a touchscreen, a biometric sensor (e.g., a fingerprint sensor), a microphone, a camera, a geographic location, and so on. The application 128 may include program logic (e.g., stored executable instructions) configured to implement at least some of the functions described herein. The application 128 may simply be a web browser (e.g., Internet Explorer®, Chrome®, Safari®, and so on) configured to receive and display web pages received from the distributed ledger network 130 and/or analysis system 110. In other arrangements, the application 128 may include a dedicated application (e.g., a smartphone application), a text message interface, or another program suitable for communicating with the analysis system 110 over the network 150.

In some arrangements, the provider computing devices 120 can be configured to query the provider database 122 for information and store information in the provider database 122. For example, the provider computing devices 120 can retrieve data stored in the provider database 122 that can be utilized to generate agreements and associated information. The data stored in the provider database 122 could include payment account information associated with a plurality of clients of a provider institution, identifying information associated with the plurality of clients of the provider institution, asset information, and a plurality of provider information. Further, the data stored in the provider database 122 may include personal information (e.g., names, addresses, phone numbers, and so on), authentication information (e.g., username/password combinations, device authentication tokens, security question answers, unique client identifiers, biometric data, geographic data, social media data, and so on), and provider information (e.g., token information, account numbers, account balances, available credit, credit history, exchange histories, and so on) relating to the various users and associated financial accounts. In some arrangements, the provider database 122 may include a subset of databases such that the analysis system 110 can analyze each database to determine the appropriate information for compliance checks and related computing tasks.

The analysis system 110 may be communicably coupled and operate the distributed ledgers nodes on the distributed ledger network 130. That is, the analysis system 110 can provider compliance checks on compliance data and execute compliance related computing tasks by utilizing the distributed ledger network 130 and other systems/devices described herein. Compliance data can be a digital representation of information associated with agreements between two parties (e.g., individual and institution, entity and provider). For example, agreements between two parties could be lending and/or trading documents, contracts, a financial exchanges, pre-nuptials, non-disclosures, grants, and so on. Further, each agreement on the distributed ledger network 130 can be associated with a blockchain, where each step (e.g., compliance event) of the agreement process can be a block, where each block connects to the previous block by means of a code, based on Blockchain technology.

In some arrangements, a blockchain can be a series of hash-linked, immutable, timestamped blocks, each block containing data (e.g., compliance data, metadata). When viewed as a linked-list data structure, a blockchain is a limited data “stack” whose operations only allow users to “push” blocks onto the top. Users are not allowed to modify blocks or to “pull” blocks off of the top. Each new block that is added is appended to the topmost block in the stack. A new block links back to the former top-of-stack block by including a hash (e.g., algorithmic numbers and/or mathematical representation) of the preceding block in the new block and binding this hash to the new block under a digital signature. That is, a hash can generated by a hash function that can be used to identify and map data (e.g., blocks). Some examples of hashing functions can be but are not limited to cryptography, compression, checksum generation, and data indexing. In various arrangement, a hash may also be used to identify the location of blocks on the distributed ledger network 130.

In some arrangements, each agreement may connect to a plurality of agreements (e.g., via mapping). For example, there is a unique loan number assigned to an applicant who can get a unique application ID that can also be linked to an account ID if it becomes active. Further in the example, a globally unique identifier (GUID) that can be used to ensure loan numbers are unique across ledgers and systems. Further in the example, as transactions (e.g., agreements) are processed the identifiers can be used to link (e.g., mapped) every transaction associated with a particular loan ID, even though transactions can randomly occur on the distributed ledger. Further in the example, the distributed ledger can be scanned to grab all transactions associated with a specific loan such that the transactions can be sorted in chronological sequence as transactions were written to the distributed ledger. Further in the example, transaction could also map to a unique account ID so all transactions with the account are linked (e.g., mapped). Further in the example, the ID links can be mapped such that each transaction can contain different data, some of which can describe what the transaction is about or a reference URL to a specific document version. Further in the example, all transactions could also carry a master ID that everything is mapped to. In some arrangements, every update (e.g., compliance event) to the agreement is recorded in the blockchain such that the nodes of the distributed ledger network 150 can provide compliance data and agreement information about each update of a specific agreement.

The analysis system 110 can also be communicably and operatively coupled to the analysis database 120 which may be configured to store a variety of information relevant to agreement data and/or compliance data utilized by compliance modeler 112 to execute various compliance related computing tasks. Information may be received from distributed ledgers nodes on the distributed ledger network 130, provider computing devices 120, and/or user devices 160, for example. In another example, transactions (e.g., agreements) can also receive time stamps and attestations as to who created the transaction. In some arrangements, transactions can be scanned to select those that match a specific ID over a specific period.

Expanding generally, the transactions and the data within them can be tested against one or more rules to ensure transactions are in compliance. Accordingly, all the data can be on the distributed ledger network 130, or some could be external (e.g., stored in an external database), some could be on the distributed ledger network 130, and some data may be verified before going off ledger (e.g., external). Event transactions can trigger contracts (sometimes referred to as “smart contracts”) and the contracts can hold the logic for the rules that need to be verified, for example, the transaction that quoted the rate and its date compared to the loan close date are in range or not. The transaction record that is first recorded could be the quote and interest. The close transaction record could append the closing details (e.g., actual rate and date), to the retrieved quote transaction recording the quoted date and rate. The application driving the transaction logic could be programmed to scan the distributed ledger network 130 for the quote transaction on loan ID X and combine the quote data with the close data and record the close transaction with the prior data. In some arrangements, the close event could trigger analysis (e.g., by analysis system 110) of the new transaction records (e.g., agreements) to systematically confirm if the transaction records are in tolerance (or not) by comparing the data. Similarly, in another arrangement, the quoted data can be retrieved from another system and written into the new close record, on the distributed ledger network 130, or the ledger could be scanned for the quote transaction and the close transaction by the analysis system 110. In other arrangements, the smart contract can be written such that a transaction comes in with new data. The contract code analyzes the new data and compares it to the previous state data recorded previously in the previous transaction. Thus, the logic can update the current state and trigger a new action.

The analysis system 110 can be configured to query the analysis database 116 for information and store information in the analysis database 116. In various arrangements, the analysis database 116 includes various transitory and/or non-transitory storage mediums. The storage mediums may include but are not limited to magnetic storage, optical storage, flash storage, RAM, and so on. The analysis database 116 and/or the analysis system 110 can use various APIs to perform database functions (i.e., managing data stored in the analysis database 120). The APIs can be but are not limited to SQL, NoSQL, NewSQL, ODBC, JDBC, and so on.

Expanding generally on analysis database 116, the data stored in the analysis database 116 may include payment account information associated with a plurality of clients of a provider institution, identifying information associated with the plurality of clients of the provider institution, compliance information, and a plurality of financial information. Further, the data stored in the analysis database 116 may include personal information (e.g., names, addresses, phone numbers, and so on), authentication information (e.g., username/password combinations, device authentication tokens, security question answers, unique client identifiers, biometric data, geographic data, social media data, and so on), and financial information (e.g., token information, account numbers, account balances, available credit, credit history, exchange histories, and so on) relating to the various users and associated financial accounts. In some arrangements, the analysis database 116 may include a subset of databases such that the analysis system 110 can analyze each database and aggregate data (e.g., utilizing the compliance data manager 114).

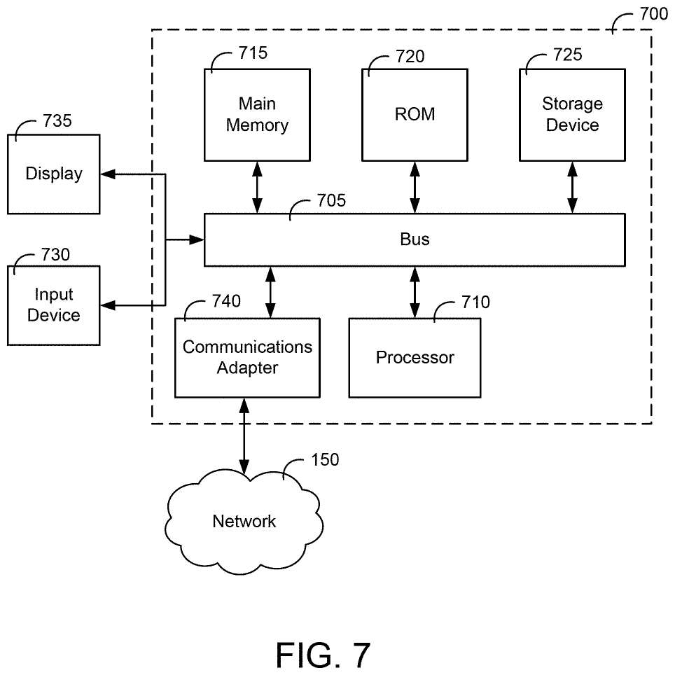

The analysis system 110 may include one or more systems (i.e., computer-readable instructions executable by a processor) and/or circuits (i.e., ASICs, Processor Memory combinations, logic circuits, and so on) configured to perform various functions of the analysis system 110, such as those described below in detail with reference to FIG. 7. In some arrangements, the systems may be or include a compliance modeler 112, and a compliance data manager 114. It should be understood that various arrangements may include more, fewer, or different systems than illustrated in FIG. 1, and all such modifications are contemplated within the scope of the present disclosure. In various arrangements, the analysis system 110 can execute smart contracts that can vary by distributed ledger technology and architectures (e.g., blockchain, non-blockchain, distributed cryptocurrency, permissionless, permissioned, proof of work, proof of stake, voting, and so on).

The compliance data manager 114 can be configured to generate and/or aggregate various data structures stored on the distributed ledger network 130 and/or analysis database 116. For example, the compliance data manager 114 can be configured to aggregate compliance data stored on the distributed ledger network 130. The compliance data may be a data structure associated with a specific agreement and indicate various compliance events. In various arrangements, the compliance events could be blocks on the blockchain associated with compliance parameters such that each block can include but is not limited to a plurality of compliance parameters. For example, compliance parameters could include a compliance event type, an execution date, an expiration date (e.g., timing requirement), one or more agreement signer, provider information, or any combination of metadata applicable with compliance events. For example, the compliance parameters of a block on the blockchain could be a credit score check compliance event type, executed on Feb. 24, 2020, expiring on Mar. 24, 2020, an agreement signer named John Doe, and a provider named Institution X. In this example, the expiration may be indicative of the date the credit score check is valid and until a new credit score check must be completed. In another example, the compliance parameters of a block on the blockchain could be a preapproval compliance event type, executed on Feb. 24, 2020, expiring on Apr. 24, 2020, an agreement signer named Jane Doe, and a provider named Institution Y. In yet another example, the compliance parameters of a block on the blockchain could be an execution of financial documents compliance event type, executed on Feb. 24, 2020, a not applicable expiration data, agreement signers named John Roe and Richard Roe, and a provider named Institution Z. In this example, the non-applicable expiration day may be indicative of the financial documents being valid throughout the lifecycle of the agreement (e.g., SSN, account number, and so on).

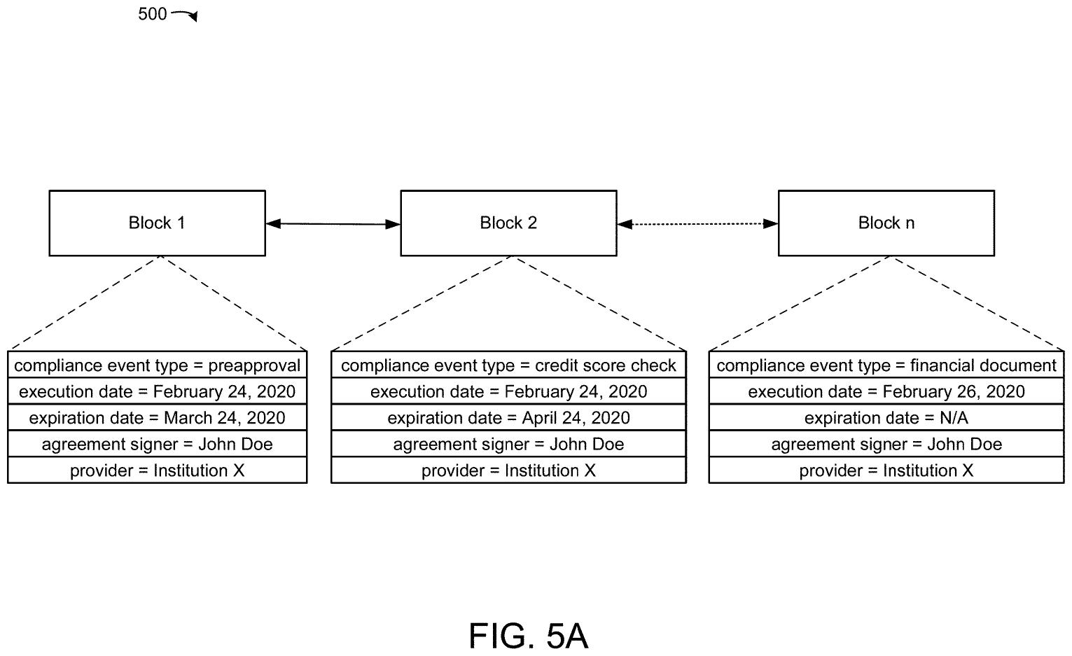

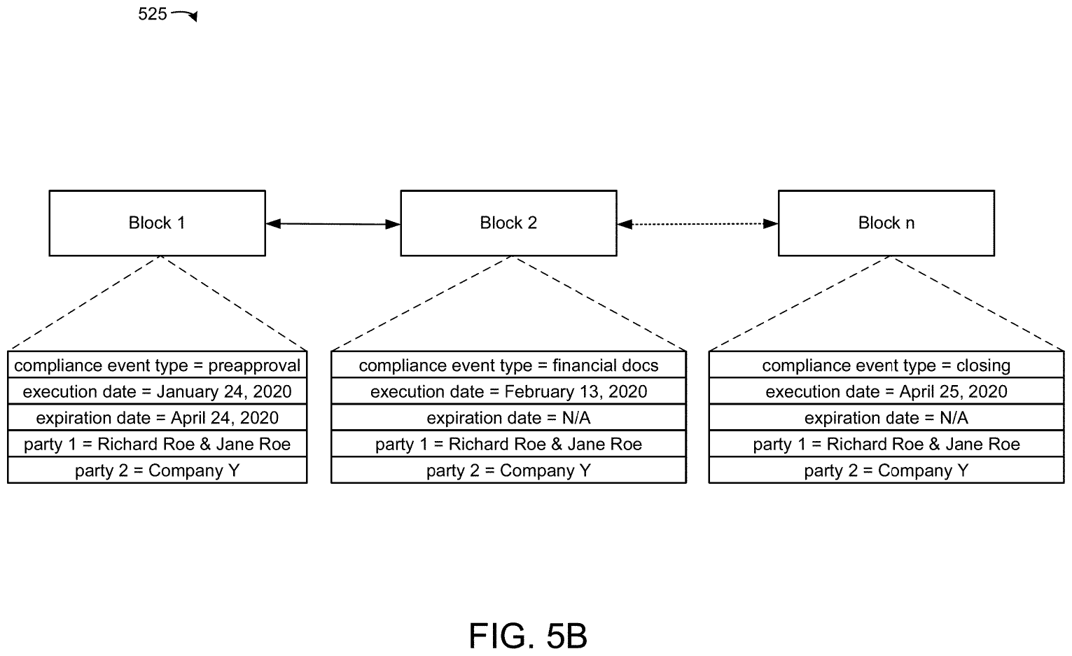

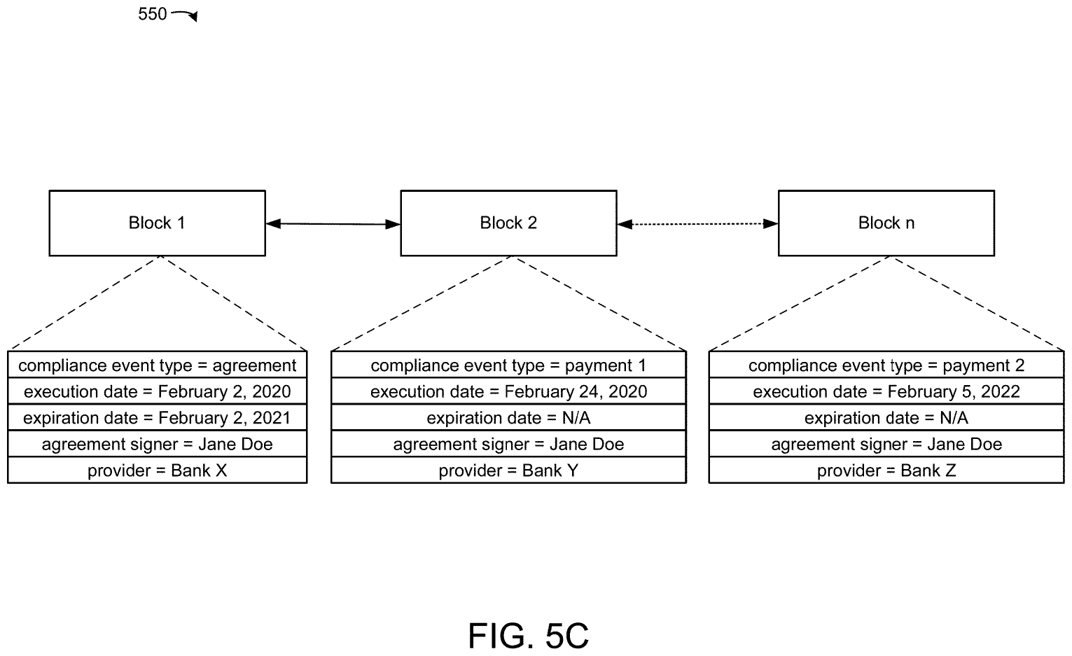

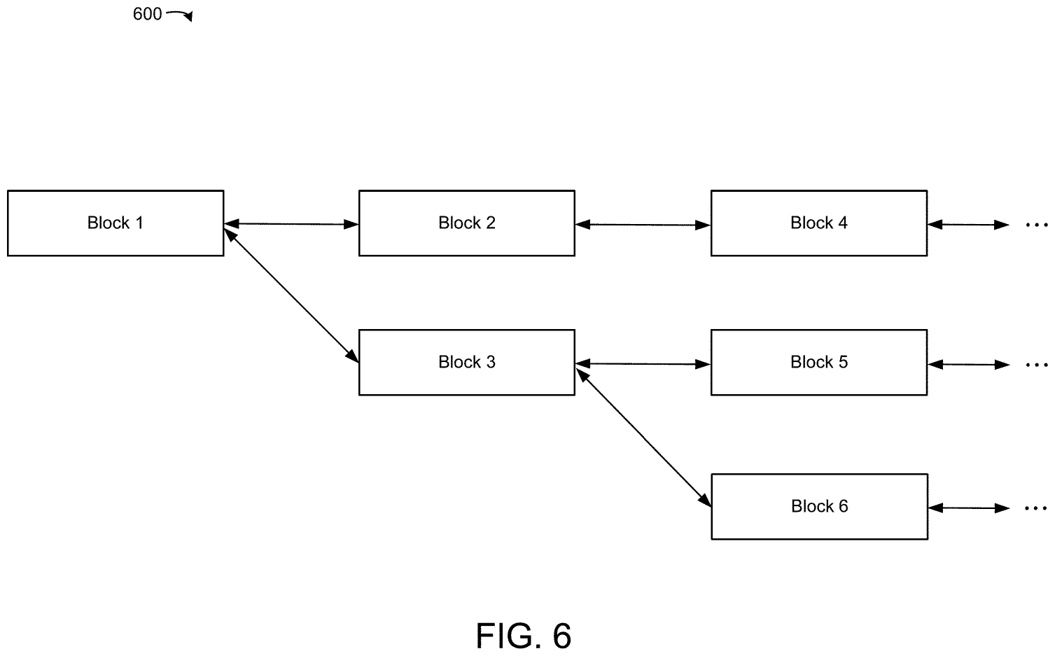

In various arrangement, the compliance parameters can include timeline data associated with a plurality of timing requirements. For example, a timing requirement may be an expiration date associated with a compliance event. In another example, a timing requirement may be a particular date that an action on a compliance event may need to be performed (e.g., signature from a user, compliance check). The blockchain and block architecture are described in further detail with reference to FIGS. 5A-5C and FIG. 6. In some arrangements, the compliance data manager 114 can communicate with the distributed ledger network 130 via network 150 in order to determine compliance data associated with agreements to be analyzed by the compliance modeler 112.

In some arrangements, the compliance modeler 112 can generate and provide (via the network 150) statistics about compliance events to independent third parties (e.g., companies with business relations, customers, clients, and so on). For example, the statistics can include statistics about discrepancies (e.g., how many, rolling averages by seconds, minutes, days, and so on), statistics about compliance events (e.g., how many, rolling averages by seconds, minutes, days, and so on), statuses of discrepancies (e.g., fixed, not fixed, currently being fixed), statuses of compliance events (e.g., active (within last 14 days), old (1 year or later), not audited, currently being audited, and so on)), and strategies and courses of actions to improve compliance for an independent third party. Independent third parties can utilize the statistics to improve aspects of the future compliance events (e.g., eliminate discrepancies) and interactions with the distributed ledger network 130.

The compliance data manager 114 can also be configured to receive compliance data associated with a plurality of agreement that each include a plurality of compliance events. That is, the compliance data may be associated with one or more provided parameters (e.g., geographic location, date range, expiration status, and so on). For example, the compliance data may be associated with a particular geographic region (e.g., Midwest, Northeast, Southeast, South, Southwest, West, Northwest, and so on). That is, each agreement could be separated into sub-groupings by a particular geographic region. In some arrangements, the compliance data manager 114 could receive GPS signals from one or more computing devices (e.g., user computing devices 160 and/or provider computing devices 120) that could include latitude data, longitude data, and any other type of location or position data to determine the location (or approximate location) of the one or more computing devices (e.g., when compliance event occur). In particular, the particular geographic region based on a GPS signal can be included in compliance data such that the compliance modeler 112 can analyze particular geographic regions of compliance events.

In another example, the compliance data may be associated with a particular date range (e.g., last 365 days, last month, last week, last day). That is, each agreement could be separated into sub-groupings by a particular date range, and where some agreements may be associated with more than one particular date range. In particular, the particular date ranges can be included in compliance data such that the compliance modeler 112 can analyze particular date ranges of compliance events. In yet another example, the compliance data may be associated with an expiration status (e.g., live, expired). That is, each agreement could be separated into sub-groupings associated with a particular expiration status.

The compliance data manager 114 can further be configured to retrieve and analyze user activity data comprising actions performed by user devices 160 over network 150. In some arrangements, the compliance data manager 114 can retrieve user activity data and creates an activity log with one or more log entries. The activity log can span over any specified time period (e.g., past month, past week, and so on) and can be specific to users based on any constraints (e.g., users in geographic areas such as United States, Los Angeles, and so on). The compliance data manager 114 may be configured to use a filtered activity log in order to determine a subset of users (i.e., a subset of the users associated with the original activity log). The subset of users may be users that executed one or more compliance events being analyzed or aggregated by the compliance data manager 114. In addition, compliance data manager 114 may be configured to retrieve user activity data related to one or more compliance parameters that can be analyzed by the compliance modeler 112.

The compliance modeler 112 can be configured to analyze compliance data. In some arrangements, analyzing compliance data can include identifying one or more corrective actions based on the compliance data and executing one or more smart contracts on the distributed ledger network 130. In various arrangements, identifying one or more corrective actions can include analyzing the generated and/or aggregated data from the compliance data manager 114 and determining one or more discrepancy in the compliance data based on the plurality of compliance parameters associated with one or more compliance events. For example, a discrepancy in compliance data could be associated with an expired compliance event, such that an expiration date (e.g., a compliance parameter) could have a date associated with a particular document of an agreement and/or condition of an agreement that has an expiration status of expired. In another example, a discrepancy in compliance data could be associated with an interest rate, such that an interest rate (e.g., a compliance parameter) of an agreement at a particular date (e.g., completion of application agreement) is contradictory to an interest rate of the agreement at a different particular date (e.g., closing of application agreement). In yet another example, a discrepancy in compliance data could be associated with a missing or incorrect signature, such that a signature (e.g., a compliance parameter) associated with a compliance event is invalid.

In some arrangements, executing one or more smart contracts on the distributed ledger network 130 can include designating (e.g., via the network 150) one or more smart contracts to execute on the distribute ledger network 130. As used herein, the phrase “smart contract” generally refers to a self-executing code (e.g., in a distributed ledger network or other system) that executes when a set of conditions that have been agreed upon by the parties of the smart contract are met. Although the figures and specification generally discuss utilizing smart contracts on agreements, the systems, methods, and apparatuses disclosed herein can also be used for a plurality of and types of financial services, such as but not limited to deeds, leases, wills, non-smart contracts, traditional legal contracts, and other types of agreements between multiple parties. That is, parties to the smart contract or other types of agreements may be individuals, companies, organizations, institutions, entities, providers, and so on.

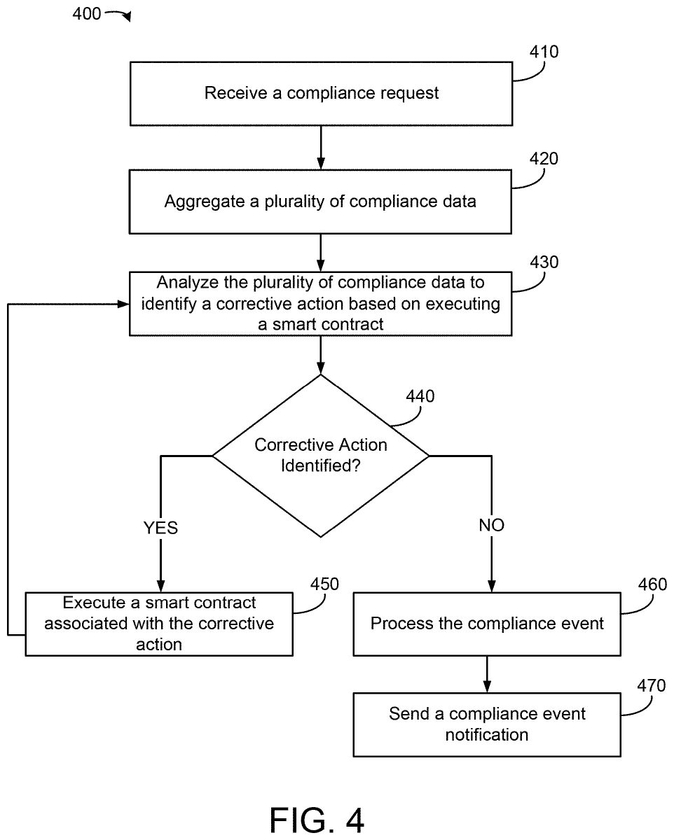

In some arrangements, executing a smart contract on the distributed ledger network 130 includes fixing the one or more discrepancies in the compliance data. In general, the self-executing code of the smart contracts can fix the one or more discrepancies (e.g., compliance events) by utilizing nodes 132A, 132B, 132C, 132D, 132E, 132F (collectively referred to herein as “nodes 132”) to generate a blockchain block (or “a blockchain transaction” in some examples) that can identify the compliance data that included the discrepancy and modifying the compliance data to fix the discrepancy. The blockchain block can then be stored on the distributed ledger network 130. In one example, the self-executing code of a smart contract could fix a compliance event that is expired by creating a new blockchain block associated with a new compliance event, with a new expiration date and that also includes all the data associated with the compliance event. The new blockchain block would then be added to a blockchain on the distributed ledger network 130. That is, in the above example, the compliance modeler 112 would determine the smart contracts to be executed based on the discrepancies in the compliance data and as a result fix the discrepancies by generating a blockchain block and storing the blockchain block on the distributed ledger network 130. In another example, the self-executing code of a smart contract could fix a compliance event that has an interest rate that is contradictory to a different compliance event by creating a new blockchain block associated with a new compliance event, with a recalculated interest rate that coincides with the different compliance event and that also includes all the data associated with the compliance event. The blockchain block would then be added to a blockchain on the distributed ledger network 130. Analyzing compliance data that can include identifying one or more corrective actions based on the compliance data and executing one or more smart contracts on the distributed ledger network 130 are described in further detail with reference to FIG. 4. In some arrangements, analyzing compliance data and executing one or more smart contracts can be done in real-time. For example, when a new compliance event is about to be created and added to as a block on the blockchain. That is, the compliance modeler 112 and/or distributed ledger network 130 can perform real-time operations on the distributed ledger network 130 to assure no discrepancies in compliance events (e.g., no corrective actions needed). In various arrangements, executing one or more smart contracts can be utilized to update a state of the compliance data, and/or perform compliance checks of compliance data associated with compliance events such that records/statistics can be generated. In another arrangement, a state change could trigger another compliance event that could trigger another execution of a smart contract.

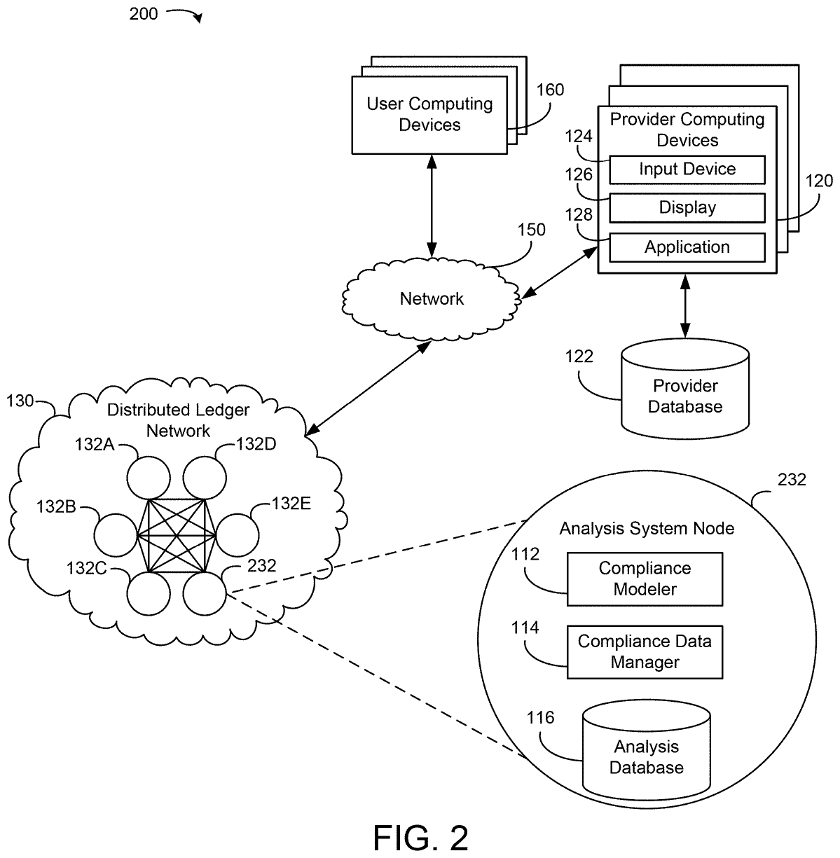

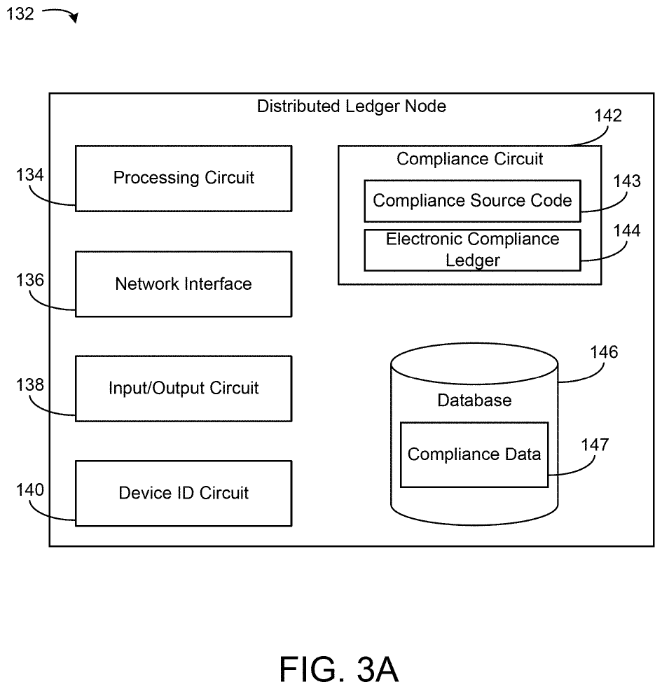

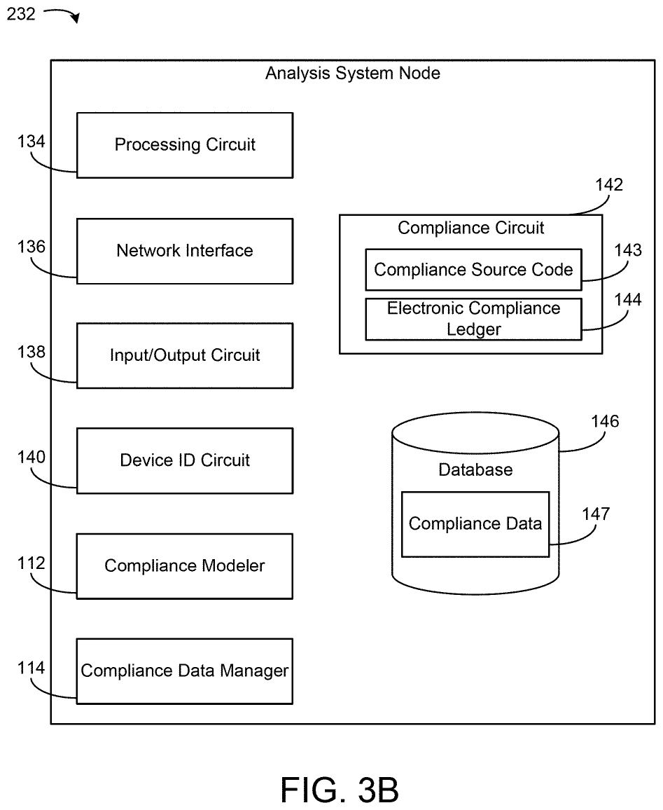

The environment 100 can also include a distributed ledger network 130 that can execute smart contracts and store compliance data associated with agreements (e.g., loans, transactions, contracts, non-disclosure, partnership, transfer). The distributed ledger network 130 can include a plurality of nodes that are interconnected with one another to form a peer-to-peer network. As shown in FIG. 1, the distributed ledger network 130 includes nodes 132A, 132B, 132C, 132D, 132E, 132F (collectively referred to herein as “nodes 132”) that are interconnected with one another to form the peer-to-peer network. Each of nodes 132 on the distributed ledger network include hardware elements, one or more processors (e.g., any general purpose or special purpose processor), and/or be operably coupled to one or more transitory and/or non-transitory storage mediums and/or memory devices (e.g., any computer-readable storage media, such as a magnetic storage, optical storage, flash storage, RAM, and so on). In some arrangements, compliance data could be associated with a specific agreement such that each agreement can be tracked throughout the agreement's lifecycle (and as described in detail with reference to FIG. 3A). In various arrangements, the analysis system 110 can be a node on the distributed ledger network 130 (and as described in detail with reference to FIGS. 2 and 3B.

Referring now to FIG. 2, a block diagram depicting an example of an analysis system node 232 and associated environment 200 is shown, according to some arrangements. The analysis system node 232 resembles similar features and functionality, described in detail with reference to FIG. 1, and in particular, nodes 132. The analysis system node 232 is shown to include a compliance modeler 112, a compliance data manager 114, and an analysis database 116 as described with respect to FIG. 1. The associated environment 100 is shown to include one or more provider computing devices 120, a provider database 122, a distributed ledger network 130, a plurality of distributed ledger nodes (e.g., 132A, 132B, 132C, 132D, 132E), a network 150, and one or more user devices 160 as described with respect to FIG. 1. However, as shown, in some arrangements, the distributed ledger network 130 includes an analysis system node 232 that can be interconnected with the nodes 132 to form a peer-to-peer network (e.g., distributed ledger network 130). Indeed, given that the analysis system node 232 is on the distributed ledger network 130, the analysis system node 232 can perform operations (e.g., compliance checks) on the distributed ledger network 130. For example, instead of communicating over the network 150 for various compliance checks and related computing tasks, the analysis system node 232 can generate, aggregate, and/or analyze various data structure e.g., communicating with nodes 132) on the distributed ledger network 130. In some arrangements, the analysis system node 232 and nodes 132 can be interconnected by any form or medium of digital data communication (e.g., a communication network). Examples of communication networks include a local area network (“LAN”) and a wide area network (“WAN”), an inter-network (e.g., the Internet), and peer-to-peer networks (e.g., ad hoc peer-to-peer networks). Additional details relating to the functions of the distributed ledger network 130 and the analysis system node 232 are provided herein with respect to FIG. 3B.

Referring now to FIG. 3A, a block diagram depicting an example of a distributed ledger node 132 of the distributed ledger network 130 in FIG. 1 is shown, according to some arrangements. That is, any of the nodes (e.g., 132A, 132B, 132C, 132D, 132E, 132F) in FIG. 1 may be a distributed ledger node 132 in FIG. 1. While various circuits, interfaces, and logic with particular functionality are shown, it should be understood that the distributed ledger node 132 can include any number of circuits, interfaces, and logic for facilitating the functions described herein. For example, the activities of multiple circuits may be combined as a single circuit and implemented on a single processing circuit (e.g., processing circuit 134), as additional circuits with additional functionality are included.

The distributed ledger node 132 can be run or otherwise be executed on one or more processors of a computing device, such as those described below in detail with reference to FIG. 7. In broad view, the distributed ledger node 132 can include a processing circuit 134, a network interface 136, an input/output circuit 138, a device ID circuit 140, a compliance circuit 142, compliance source code 143, an electronic compliance ledger 144, a database 146, and compliance data 147. In some arrangements, the distributed ledger node 132 can include a processing circuit 134 composed of one or more processors and memory.

The distributed ledger node 132 can include a network interface 136 configured to establish a communication session with a computing device for sending and receiving data over the network 150 to the computing device. Accordingly, the network interface 136 includes a cellular transceiver (supporting cellular standards), a global positioning system (GPS) transceiver (supporting GPS standards), a local wireless network transceiver (supporting 802.11X, ZigBee, Bluetooth, Wi-Fi, or the like), a wired network interface, a combination thereof (e.g., both a cellular transceiver, GPS transceiver, and a Bluetooth transceiver), and/or the like. In some arrangements, the distributed ledger node 132 includes a plurality of network interfaces 136 of different types, allowing for connections to a variety of networks, such as local area networks or wide area networks including the Internet, via different sub-networks.

The distributed ledger node 132 can include an input/output circuit 138 configured to receive user input from and provide information to a user of the distributed ledger node 132. In this regard, the input/output circuit 138 is structured to exchange data, communications, instructions, and so on with an input/output component of the distributed ledger node 132. Accordingly, input/output circuit 138 may be any electronic device that conveys data to a user by generating sensory information (e.g., a visualization on a display, one or more sounds, tactile feedback, and so on) and/or converts received sensory information from a user into electronic signals (e.g., a keyboard, a mouse, a pointing device, a touch screen display, a microphone, and so on). One or more user interfaces may be internal to the housing of the distributed ledger node 132, such as a built-in display, touch screen, microphone, and so on, or external to the housing of the distributed ledger node 132, such as a monitor connected to the distributed ledger node 132, a speaker connected to the distributed ledger node 132, and so on, according to various arrangements. In some arrangements, the input/output circuit 138 includes communication circuitry for facilitating the exchange of data, values, messages, and the like between the input/output device and the components of the distributed ledger node 132. In some arrangements, the input/output circuit 138 includes machine-readable media for facilitating the exchange of information between the input/output device and the components of the distributed ledger node 132. In still another arrangement, the input/output circuit 138 includes any combination of hardware components (e.g., a touchscreen, biometric sensor), communication circuitry, and machine-readable media.

The distributed ledger node 132 can include a device identification circuit 140 (shown in FIG. 3A as device ID circuit 140) configured to generate and/or manage a device identifier associated with the distributed ledger node 132. The device identifier may include any type and form of identification used to distinguish the distributed ledger node 132 from other computing devices and/or other distributed ledger nodes. In some arrangements, a device identifier may be associated with one or more other device identifiers. In some arrangements, to preserve privacy, the device identifier may be cryptographically generated, encrypted, or otherwise obfuscated by any circuit of the distributed ledger node 132. In some arrangements, the distributed ledger node 132 may include the device identifier in any communication (compliance requests, compliance events, compliance data in FIG. 1) that the distributed ledger node 132 sends to a computing device (e.g., analysis system 110).

The distributed ledger node 132 can include a compliance circuit 142 composed of compliance source code 143 and an electronic compliance ledger 144. The compliance source code 143 may be stored in memory of processing circuit 134, which may be accessed by and/or run on processing circuit 134. The electronic compliance ledger 144 may be stored on the same and/or different processor readable memory, which may be accessible by processing circuit 134 when running the compliance source code 143. In some arrangements, the electronic compliance ledger 144 on a first node (e.g., node 132A in FIG. 1) of a distributed ledger network corresponds with the electronic compliance ledger of one or more nodes within the distributed ledger network, to the extent that the nodes have synchronized/updated their electronic compliance ledgers (e.g., received the latest compliance data via a download or during a reconciliation process). Accordingly, the electronic compliance ledger 144 may be a public ledger.

In some arrangements, compliance events on the distributed ledger network 130 include utilizing smart contracts (e.g., virtual contracts/agreements and as disclosed above with reference to FIG. 1). In one example, the electronic compliance ledger 144 can be a blockchain that can be a distributed database (e.g., distributed ledger network 130) that maintains a continuously growing list of records (e.g., compliance events) called blocks that hold information (e.g., compliance data and/or compliance parameters). Each block in the blockchain can contain, among other data, a timestamp and a link to a previous block. In various arrangement, a block in the blockchain can include a link to a plurality of block (collectively referred to herein “mapping” and described in further detail with reference to FIG. 6). In some arrangements, smart contracts can be utilized to perform a plurality of actions (e.g., identifying correction actions, updating compliance data, analyzing compliance events).

The distributed ledger node 132 can include at least one database 146. The database 146 can include data structures (e.g., datasets) for storing information such as the metadata about compliance events (e.g., smart contract execution history), compliance data, agreements, distributed ledger node information, or additional information. Further, the data stored in the database 146 may include personal information (e.g., names, addresses, phone numbers, and so on), authentication information (e.g., username/password combinations, device authentication tokens, security question answers, unique client identifiers, biometric data, geographic data, social media data, and so on), and financial information (e.g., token information, account numbers, account balances, available credit, credit history, exchange histories, and so on) relating to the various agreements. The database 146 can be part of the distributed ledger node 132, or a separate component that the distributed ledger node 132, analysis system 110, user computing devices 160, and/or provider computing devices 120 can access via the network 150. The database 146 can also be distributed throughout distributed ledger network 130 and/or environment 100. For example, the database 146 can include multiple databases associated with the distributed ledger nodes on the distributed ledger network 130, analysis system 110, and provider computing devices 120, or all three. In some arrangements, each node on the distributed ledger network 130 (e.g., 132A, 132B, 132C, 132D, 132E, and 132F) includes a database such that each database contains the same data (e.g., electric compliance ledger, and metadata about compliance events). In some arrangements, each data structure can be combined into one dataset.

The database 146 can include a data structure (e.g., dataset) associated with compliance data 147. The compliance data 147 can include a plurality of metadata about compliance events and agreements. That is, agreements can include metadata associated with each agreement (e.g., agreement parties, interest rate, agreement amount, dates, and so on) and compliance events on the electronic compliance ledger 144 can include metadata associated with each compliance event (e.g., compliance parameters). In some arrangements, metadata could include each smart contract that has been executed associated with that agreement. In various arrangements, metadata could include any data that describes characteristics or aspects of the specific agreement. For example, metadata could include a unique tracking identifier such that each compliance event can be uniquely identified. In another example, metadata could include personal information (e.g., names, addresses, phone numbers, and so on), authentication information (e.g., username/password combinations, device authentication tokens, security question answers, unique client identifiers, biometric data, geographic data, social media data, and so on), and financial information (e.g., token information, account numbers, account balances, available credit, credit history, exchange histories, and so on) associated with the parties of the agreement. In another example, the metadata could include timing information (e.g., compliance parameter) such that timing requirement and deadlines can be set associated with a specific compliance event. In yet another example, the metadata could include mapping information such that compliance events can be mapped to a plurality of different compliance events. In some arrangements, to preserve privacy, any metadata associated with the compliance events may be cryptographically generated, encrypted, or otherwise obfuscated by any circuit of the distributed ledger node 132.

In some arrangements, a distributed ledger node 132 of a distributed ledger network (e.g., distributed ledger network 130 in FIG. 1) may be configured to send and/or receive, via the network 150, data associated with the electronic compliance ledger 144 to an analysis system 110 (e.g., compliance data manager 114) and/or any other device in environment 100. In various arrangements, a distributed ledger node 132 of a distributed ledger network (e.g., distributed ledger network 130 in FIG. 1) may be configured to send and/or receive, via the network 150, data associated with the database 146 to an analysis system 110 and/or any other device in environment 100. In some arrangements, after a successful completion and/or failure of an execution of a command/commands, the processing circuit 134/network interface 136 may provide a confirmation/failure notification to one or more systems described herein (e.g., analysis system 110 in FIG. 1).

In some examples, a confirmation notification can be sent to a user computing device in response to a successful execution of a corrective action. A failure notification (or “error notification” in some examples) can be sent to a user computing device in response to a failed execution of a corrective action. In one example, the rate-lock interest rate may be modified from a first rate (e.g., 3.25%) to a second, lower rate (e.g., 3.125%) in response to successful execution of a corrective action. In another example, the rate-lock interest rate may stay the same (e.g., 3.25%) in response to a failed execution of a corrective action. In this example, the loan may not be able to process (e.g., become closed) until a successful execution of the corrective action. Accordingly, in some arrangements, an execution of a corrective action may be performed until the corrective action is successful executed. In this example, a notification may be provided to a user computing device to indicate each time execution of a corrective action has failed to indicate the same and to indicate that execution of the corrective action will continue until the corrective action is successfully executed.

In some arrangements, the distributed ledger node 132 may be configured to receive (via the network interface 136) a compliance request from the analysis system 110 and in particular, compliance modeler 112. The compliance request can designate a specific compliance event to be utilized to execute various real-time actions (e.g., smart contracts, compliance checks, corrective actions). In some arrangements, the compliance request can designate a plurality of compliance events to be utilized to execute various actions. Additional details associated with the compliance request is described in detail with reference to method 400 in FIG. 4.

In some arrangements, the request may include a smart contract, that when executed by the distributed ledger node 132, causes the distributed ledger node 132 of the distributed ledger network 130 to monitor/detect the exchanges that are made by the distributed ledger node 132. The distributed ledger node 132 may store the smart contract in database 146. When an exchange request is sent or received by the distributed ledger node 132 on the distributed ledger network 130, the smart contract may execute and as a result update the electric compliance ledger 144 and subsequently the compliance data 147. In various arrangements, each command can include program code (e.g., a script, an executable) that, when executed by a distributed ledger node (e.g., 132A) of the distributed ledger network 130, causes the node to execute a specific set of instructions.

In various arrangements, the command may cause the distributed ledger node 132 to send the command (or copies thereof) to other nodes in the distributed ledger network 130, thereby causing those nodes to also perform the command. The distributed ledger node 132 can include a bus (not shown, discussed in detail with reference to FIG. 7), such as an address/data bus or other communication mechanism for communicating information, which interconnects circuits and/or subsystems (e.g., compliance circuit 142) of the distributed ledger node 132. In some arrangements, the distributed ledger node 132 may include one or more of any such circuits and/or subsystems.

In some arrangements, some or all of the circuits of the distributed ledger node 132 may be implemented with the processing circuit 134. For example, any of the distributed ledger node 132 may be implemented as a software application stored within the memory and executed by the processor of processing circuit 134. Accordingly, such arrangement can be implemented with minimal or no additional hardware costs. In some arrangements, any of these above-recited circuits rely on dedicated hardware specifically configured for performing operations of the circuit. In some arrangements, each node is associated with a provider computing device (e.g., provider computing devices 120 in FIG. 1). That is, each provider computing device may run a dedicated distributed ledger node. In this arrangement, the dedicated distributed ledger node could utilize resources of the provider computing device or vice versa.

As shown, the arrangements described herein improve compliance models that would otherwise need, if even possible, significant computing time, processing power, and network bandwidth to determine corrective actions associated with compliance events of agreements. Indeed, the compliance model disclosed herein provides a permanent record of all history activities (e.g., compliance events) and automatically performs real-time operations on the compliance data such that it significantly reduces, computing time, processing power, and network bandwidth, enabling computing devices (e.g., distributed ledger nodes) to execute other instruction that could not been executed previously.

Referring now to FIG. 3B, a block diagram depicting an example of an analysis system node 232 of the distributed ledger network 130 in FIG. 2 is shown, according to some arrangements. The analysis system node 232 resembles similar features and functionality, described in detail with reference to FIG. 3A, and in particular, distributed ledger node 132. The analysis system node 232 is shown to include a compliance modeler 112, a compliance data manager 114, and an analysis database 116 as described with respect to FIG. 1. Further, the analysis system node 232 is shown to include a processing circuit 134, a network interface 136, an input/out circuit 138, a device id circuit 140, a compliance circuit 142, compliance source code 143, an electronic compliance ledger 144, a database 146, and compliance data 147 as described with respect to FIG. 3A. However, as shown, in some arrangements, the distributed ledger network 130 includes an analysis system node 232 that can be interconnected with the nodes 132 to form a peer-to-peer network (e.g., distributed ledger network 130). Indeed, given that the analysis system node 232 is on the distributed ledger network 130, the analysis system node 232 can perform various operations (e.g., compliance checks) on the distributed ledger network 130. For example, instead of communicating over the network 150 for various compliance checks and related computing tasks, the analysis system node 232 can generate, aggregate, and/or analyze various data structures (e.g., communicating with nodes 132) on the distributed ledger network 130. That is, any of the nodes (e.g., 132A, 132B, 132C, 132D, 132E, 132F) in FIG. 1 may be an analysis system node 232. While various circuits, interfaces, and logic with particular functionality are shown, it should be understood that the analysis system node 232 can include any number of circuits, interfaces, and logic for facilitating the functions described herein. For example, the activities of multiple circuits may be combined as a single circuit and implemented on a single processing circuit (e.g., processing circuit 134), as additional circuits with additional functionality are included.

Referring now to FIG. 4, a flowchart for a method 400 of data verification for compliance models on a distributed ledger network is shown, according to some arrangements. System 100 and/or System 200 can be configured to perform method 400. Further, any computing device described herein can be configured to perform method 400.

In broad overview of method 400, at block 410, the one or more processing circuits receive a compliance request associated with a compliance event. At block 420, the one or more processing circuits aggregate compliance data associated with the compliance event. At block 430, the one or more processing circuits analyze the compliance data including identifying a corrective action. At block 440, the one or more processing circuits determine if a corrective action is identified. At block 450, in response to successfully identifying a corrective action, the one or more processing circuits execute a smart contract associated with the corrective action. That is, after the execution at block 450, the method 400 returns to block 430. At block 460, in response to unsuccessfully identifying a corrective action, one or more processing circuits process the compliance event. At block 470, the one or more processing circuits send a compliance event notification.

Referring to method 400 in more detail, at block 410, the one or more processing circuits (e.g., analysis system 110, provider computing devices 120, and/or user computing devices 160 in FIG. 1) receive a compliance request associated with a compliance event, the compliance request includes account information of a customer of a provider institution. In various arrangements, referring to FIGS. 1-2, the compliance request can be sent from an analysis system 110 to one or more nodes 132 on the distributed ledger network 130. The compliance request can be associated with a financial agreement between the customer and the provider institution. In some arrangements, the compliance request can designate a compliance event to be utilized to execute various real-time actions (e.g., smart contracts, compliance checks, corrective actions). For example, the compliance request can include a unique identifier associated with a specific compliance request. In another example, the compliance request can include identifying information, such as compliance data associated with a specific compliance request. In some arrangements, the compliance request can be sent from a computing device within the distributed ledger network 130. For example, as shown with reference to FIG. 3B if an analysis system 232 is a node on the distribute ledger network 130.

In some arrangements, the compliance request could be associated with a plurality of compliance events. That is, the compliance request may designate the plurality of compliance events that meet a certain requirement. For example, a compliance request requirement may be all compliance events within the last week, month or year. In another example, a compliance request requirement may be a certain geographic area (e.g., state specific, region specific). In yet another example, a compliance request requirement may be a certain provider (e.g., company X, branch Y, financial institution Z) and/or a certain party (e.g., account number, name, other identifying information). Accordingly, the compliance request can include a plurality of information associated with one or more compliance events that are to be utilized to execute various actions.

At block 420, the one or more processing circuits aggregate compliance data associated with the compliance event and stored on the distributed ledger network. That is, each node on the distributed ledger network may contain a copy of a plurality of databases associated with a plurality of compliance events. In some arrangements, aggregating may include using a machine learning algorithm (e.g., a neural network, convolutional neural network, recurrent neural network, linear regression model, sparse vector machine, and so on). The one or more processing circuits can input one or more compliance requests and/or compliance events into the machine learning model and receive an output from the model indicating all the data associated with the compliance event in the database. In some arrangements, aggregating compliance data can be performed by the compliance data manager 114 of FIG. 1. The compliance data manager 114 can communicate with nodes (e.g., nodes 132) on the distributed ledger network 130 to retrieve compliance data associated with one or more compliance events. As described above, the analysis system 110 (also compliance data manager 114) can to be on the distributed ledger network 130 (e.g., analysis system node 232).

In various arrangements, aggregating may include analyze each block on the blockchain to identify compliance data associated with one or more compliance events. The compliance data may then be extracted from the blocks on the blockchain and stored together (e.g., Analysis database 116 in FIG. 1). In some arrangements, aggregating may include analyzing a plurality of nodes on the distributed ledger network 130 to identify compliance data associated with each node. The compliance data may then be extracted from each node and stored together. In various arrangements, the compliance data may sorted before it is stored (e.g., by date, by node by characteristics. In various arrangements, the compliance data may be stored in cache of one or more processing circuits such that the analysis system 110 can quickly access the compliance data for further operations and various tasks (e.g., analyzing).

At block 430, the one or more processing circuits analyze the compliance data, wherein analyzing the compliance data can include identifying a corrective action based on the compliance data and executing a first smart contract on the distributed ledger network. In some arrangements, compliance events can be associated with a plurality of compliance parameters (e.g., a compliance event type, an execution date, an expiration date, one or more agreement signer, provider information, or any combination of metadata applicable with compliance events), and where identifying one or more corrective actions is based on identifying a discrepancy in the compliance data. In some arrangements, a discrepancy could include inaccurate information associated with the agreement. For example, the inaccurate information associated with the agreement could be a different interest rate than originally determined from a different compliance event. In another example, the inaccurate information associated with the agreement could be an expiration status of expired. In one arrangement, the one or more processing circuits may successfully identify a corrective action. In another arrangement, the one or more processing circuits may unsuccessful identify a corrective action. In various arrangements, a plurality of corrective actions may be identified such that each corrective action may be identified, and one or more smart contracts may be executed. In various arrangements, analyzing of the compliance data can be performed by executing one or more smart contracts.

At block 440, the one or more processing circuits can determine if a corrective action is identified. In one arrangement, if a corrective action is successfully identified, as discussed with reference to block 430, method 430 continues to block 450. In another arrangement, if a corrective action is unsuccessfully identified, as discussed with reference to block 430, method 430 continues to block 460.

At block 450, the one or more processing circuits execute, on the distributed ledger network, a second smart contract associated with the corrective action, wherein executing the second smart contract includes updating the compliance data to include the corrective action. In some arrangements, updating the compliance data can include fixing one or more discrepancies. That is, fixing one or more discrepancies can include the one or more processing circuits generating a blockchain block, in real-time, that includes identifying the compliance data that included the discrepancy and modifying the compliance data to fix the discrepancy. Subsequently, the one or more processing circuits can store the blockchain block on the distributed ledger network 130 in FIGS. 1A-1B. For example, in a home loan application the quoted interest rate may be different than the current interest rate. In this example, the one or more processing circuits can analyze the compliance data to determine which interest rate is correct (e.g., is there a rate-lock, is the rate-lock expired, was there a modification to the application that would result in calculating a new interest rate, and so on) such that a corrective action can performed on the compliance data, which can include generating a new blockchain block recording the corrective action.

At block 460, the one or more processing circuits process the compliance event, wherein processing the compliance event includes generating a blockchain block based on the compliance data and storing the blockchain block on the distributed ledger network. In some arrangements, in response to block 430 unsuccessfully identifying a corrective action (e.g., no discrepancies in the compliance events), the one or more processing circuits can process a compliance event in real-time. For example, the compliance event could be a closing on a loan agreement where the interest rate at the beginning of the loan agreement matches the interest rate currently. In this example, the one or more processing circuits can generate a blockchain block based on the compliance data and store the blockchain block to a blockchain on the distributed ledger network. In some arrangements, the new blockchain block may be mapped to a plurality of other blockchain blocks (and as described in detail with reference to FIG. 6). In various arrangements, processing the compliance event can also include recording the corrective action in a previously generated blockchain block or in an external database.

At block 470, the one or more processing circuits send, to a user computing device, a compliance event notification including the compliance data, wherein the user computing device is associated with the customer (e.g., parties) of the provider institution. In some arrangements, the compliance event notification can be sent by one or more nodes (e.g., nodes 132 and/or analysis system node 232 in FIGS. 1-2) on the distributed ledger network 130, as shown in FIG. 1, to one or more computing devices of the customer (e.g., user computing devices 160). In one example, the compliance event notification may be any type of communication exchanged over a network 150 (e.g., text message, email, ping, phone call, provider institution portal notification, social media notification, and so on). In other arrangements, the compliance event notification may be generated by an independent third party. The independent third party may utilize an application to monitor the distributed ledger network 130 such that when states and/or compliance events occur on the distributed ledger network a notification may be sent to a user computing device of the customer or a new smart contract with new compliance data and state information may be generated and stored on the distributed ledger network 130.

Referring now to FIGS. 5A-5C, example illustrations of compliance models utilizing timing are shown, according to some arrangements. As shown, each of FIGS. 5A-5C include a plurality of blocks on a blockchain. In the illustrated arrangements, a plurality of compliance data (e.g., compliance event type, execution date, expiration date, parties, agreement signer, providers) can include a subset of compliance data referred to as compliance parameters (e.g., expiration date). In some arrangements, the distributed ledger network 130 can utilize timing to ensure each compliance event is proper. That is, for a compliance event to be proper, among other requirements, the compliance events timing should be correct (e.g., expiration dates are not past).

Expanding generally on compliance event timing, the compliance parameters can include timeline data associated with a plurality of timing requirements. In some arrangements, the timeline data can be an ordered list of compliance events with timing requirement based on a date or time of execution (e.g., performed during aggregation of compliance data as described in detail with reference to FIG. 1). In one example, the ordered list can be blocks on a blockchain, such that each block includes an execution date, and an expiration date (e.g., time requirement). That is, timeline data can be included in compliance data where a subset of timeline data can be timing requirement. The timing requirements can be predefined dates and/or times that are to be met to assure one or more compliance event are proper. In various arrangement, if a timing requirement included in timeline data is not met (e.g., past date and/or time or timing requirement), a corrective action may be performed to correct the compliance data to ensure each compliance event is proper. In various arrangements, timeline data can include any date or time that may prompt one or more processing circuits to perform an action associated with a specific compliance event. For example, timeline data could also include a reminder date such that one or more processing circuits can notify a user and/or provider that a particular day (e.g., expiration date) is a certain amount of days away (e.g., 7 days from expiration).

In various arrangement, if an expiration date (e.g., time requirement) is passed, the compliance event may require a real-time corrective action (e.g., new block generated with new expires date). In one example, with reference to FIG. 5A, Block 1 includes an expiration date of Mar. 24, 2020. In this example, Block 2 and Block n are subsequently added to the blockchain. As seen, each block on the blockchain is within the preapproval event type expiration date such that no discrepancies exist on the blockchain (e.g., no corrective action needed). However, in a different example, with reference to FIG. 5B, Block 1 includes an expiration date of Apr. 24, 2020. In this example, Block 2 and Block n are subsequently added to the blockchain. As shown, Block n was executed and added to the blockchain on Apr. 25, 2020 which is one day past the expiration date of Block 1 (e.g., preapproval). Accordingly, a discrepancy in the blockchain can be noticed and a real-time corrective action may be performed to fix the discrepancy. For example, by generating a new block on the blockchain (e.g., Block o) associated with a preapproval event type. That is, in this example, the closing may need to be executed again based on the new block on the blockchain. In yet another example, with reference to FIG. 5C, Block n was added to the blockchain after the agreement event type expired. Accordingly, as discussed above, a new block may be added to the blockchain associated with the agreement before payment 2 can be proper. In some arrangements, payment 2 may have to be executed again as a new block to the blockchain after the new agreement event type block is added.

Referring now to FIG. 6, an example illustration of compliance models utilizing mapping is shown, according to some arrangements. In some arrangements, each block (e.g., Block 1, Block 2, Block 3, Block 4, Block 5, Block 6, and so on, collectively referred to herein as “Blocks”) can include compliance data associated with an agreement. In one example, each Block associated with an agreement may include a unique ID of a home loan for a customer. As shown, each block may be part of a single agreement, or part of a plurality of agreements. In various arrangements, an analysis system (e.g., analysis system 110 of FIG. 1) may sort or organize groups (e.g., map) of agreements together based on variety of characteristics (e.g., dates, geolocation, provider institution location, unique ID's, type of agreement, and so on). In various arrangement, the Blocks may be mapped sequentially by date/time. In other arrangement, the Blocks may be mapped randomly or by a plurality of other rules.

FIG. 7 illustrates a depiction of a computer system 700 that can be used, for example, to implement an example analysis system 110, example provider computing devices 120, example user computing devices 160, an example distributed ledger network 130, and/or various other example systems described in the present disclosure. The computing system 700 includes a bus 705 or other communication component for communicating information and a processor 710 coupled to the bus 705 for processing information. The computing system 700 also includes main memory 715, such as a random-access memory (RAM) or other dynamic storage device, coupled to the bus 705 for storing information, and instructions to be executed by the processor 710. Main memory 715 can also be used for storing position information, temporary variables, or other intermediate information during execution of instructions by the processor 710. The computing system 700 may further include a read only memory (ROM) 720 or other static storage device coupled to the bus 705 for storing static information and instructions for the processor 710. A storage device 725, such as a solid-state device, magnetic disk or optical disk, is coupled to the bus 705 for persistently storing information and instructions.

The computing system 700 may be coupled via the bus 705 to a display 735, such as a liquid crystal display, or active matrix display, for displaying information to a user. An input device 730, such as a keyboard including alphanumeric and other keys, may be coupled to the bus 705 for communicating information, and command selections to the processor 710. In another arrangement, the input device 730 has a touch screen display 735. The input device 730 can include any type of biometric sensor, a cursor control, such as a mouse, a trackball, or cursor direction keys, for communicating direction information and command selections to the processor 710 and for controlling cursor movement on the display 735.

In some arrangements, the computing system 700 may include a communications adapter 740, such as a networking adapter. Communications adapter 740 may be coupled to bus 705 and may be configured to enable communications with a computing or communications network 130 and/or other computing systems. In various illustrative arrangements, any type of networking configuration may be achieved using communications adapter 740, such as wired (e.g., via Ethernet), wireless (e.g., via WiFi, Bluetooth, and so on), satellite (e.g., via GPS) pre-configured, ad-hoc, LAN, WAN, and so on.

According to various arrangements, the processes that effectuate illustrative arrangements that are described herein can be achieved by the computing system 700 in response to the processor 710 executing an arrangement of instructions contained in main memory 715. Such instructions can be read into main memory 715 from another computer-readable medium, such as the storage device 725. Execution of the arrangement of instructions contained in main memory 715 causes the computing system 700 to perform the illustrative processes described herein. One or more processors in a multi-processing arrangement may also be employed to execute the instructions contained in main memory 715. In alternative arrangements, hard-wired circuitry may be used in place of or in combination with software instructions to implement illustrative arrangements. Thus, arrangements are not limited to any specific combination of hardware circuitry and software.

That is, although an example processing system has been described in FIG. 7, arrangements of the subject matter and the functional operations described in this specification can be carried out using other types of digital electronic circuitry, or in computer software embodied on a tangible medium, firmware, or hardware, including the structures disclosed in this specification and their structural equivalents, or in combinations of one or more of them. Arrangements of the subject matter described in this specification can be implemented as one or more computer programs, e.g., one or more subsystems of computer program instructions, encoded on one or more computer storage medium for execution by, or to control the operation of, data processing apparatus. Alternatively, or in addition, the program instructions can be encoded on an artificially generated propagated signal, e.g., a machine generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The terms “data processing system” or “processor” encompass all kinds of apparatus, devices, and machines for processing data, including by way of example, a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a circuit, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more subsystems, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, arrangements of the subject matter described in this specification can be carried out using a computer having a display device, e.g., a quantum dot display (QLED), organic light-emitting diode (OLED), or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, tactile input, or other biometric information. In addition, a computer can interact with a user by sending documents to and receiving documents from a device that is used by the user; for example, by sending web pages to a web browser on a user's client device in response to requests received from the web browser.

Arrangements of the subject matter described in this specification can be carried out using a computing system that includes a back-end component, e.g., as a data server, or that includes a middleware component, e.g., an application server, or that includes a front-end component, e.g., a client computer having a graphical user interface or a web browser through which a user can interact with an arrangement of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter¬network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some arrangements, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some illustrative arrangements, the features disclosed herein may be implemented on a smart television circuit (or connected television circuit, hybrid television circuit, and so on), which may include a processing circuit configured to integrate Internet connectivity with more traditional television programming sources (e.g., received via cable, satellite, over-the-air, or other signals). The smart television circuit may be physically incorporated into a television set or may include a separate device such as a set-top box, Blu-ray or other digital media player, game console, hotel television system, and other companion device. A smart television circuit may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television circuit may be configured to provide a home screen or top-level screen including icons for a plurality of different applications, such as a web browser and a plurality of streaming media services, a connected cable or satellite media source, other web “channels,” and so on. The smart television circuit may further be configured to provide an electronic programming guide to the user. A companion application to the smart television circuit may be operable on a mobile computing device to provide additional information about available programs to a user, to allow the user to control the smart television circuit, and so on. In alternate arrangements, the features may be implemented on a laptop computer or other personal computer, a smartphone, other mobile phone, handheld computer, a tablet PC, or other computing device.

While this specification contains many specific arrangement details, these should not be construed as limitations on the scope of the present disclosure or of what may be claimed, but rather as descriptions of features specific to particular arrangements of the present disclosure. Certain features that are described in this specification in the context of separate arrangements can also be carried out in combination or in a single arrangement. Conversely, various features that are described in the context of a single arrangement can also be carried out in multiple arrangements, separately, or in any suitable sub combination. Moreover, although features may be described above as acting in certain combinations and even initially claimed as such, one or more features from a claimed combination can, in some cases, be excised from the combination, and the claimed combination may be directed to a sub combination or variation of a sub combination.

Additionally, features described with respect to particular headings may be utilized with respect to and/or in combination with illustrative arrangement described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the arrangements described above should not be understood as requiring such separation in all arrangements, and it should be understood that the described program components and systems can generally be integrated together in a single software product or packaged into multiple software products embodied on tangible media.

Thus, particular arrangements of the subject matter have been described. Other arrangements are within the scope of the following claims. In some cases, the actions recited in the claims can be performed in a different order and still achieve desirable results. In addition, the processes depicted in the accompanying figures do not necessarily need the particular order shown, or sequential order, to achieve desirable results. In certain arrangements, multitasking and parallel processing may be advantageous.

1. A computer-implemented method of data verification for a compliance model on a distributed ledger network, the method comprising:
receiving, by one or more processing circuits, a compliance request for a plurality of compliance events satisfying at least one requirement, the compliance request comprises account information of a customer of a provider institution, and wherein each compliance event of the plurality of compliance events is a blockchain block on the distributed ledger network and comprises metadata fields for a specific agreement of a plurality of agreements with the provider institution, the metadata fields comprising at least an interest rate, an expiration date, and compliance event type, and wherein each blockchain block is mapped on the distributed ledger network into sub-groupings based on a geographic location of the compliance event;
aggregating, by the one or more processing circuits, compliance data associated with the plurality of compliance event in a particular geographic region based on:
analyzing, utilizing mapping data based on the geographic location, the distributed ledger network; and
extracting the compliance data from cache of the one or more processing circuits and a plurality of nodes on the distributed ledger network based on determining the plurality of compliance events that satisfy the at least one requirement and in the particular geographic region;
analyzing, by the one or more processing circuits, the compliance data, wherein analyzing the compliance data comprises:
identifying a real-time corrective action based on executing a first smart contract on the distributed ledger network, wherein identifying the real-time corrective action comprises identifying a first interest rate of a first compliance event is different than a second interest rate of a second compliance event, wherein the first compliance event is associated with a first compliance event type and the second compliance event is associated with a second compliance event type; and
identifying at least one discrepancy in the metadata fields of the compliance data of the first compliance event, wherein identifying the at least one discrepancy comprises determining the first interest rate is incorrect based on either the expiration date or a modification to the specific agreement; and
in response to successfully identifying the real-time corrective action, automatically executing, by the one or more processing circuits on the distributed ledger network and in real-time, a second smart contract associated with the real-time corrective action, wherein executing the second smart contract comprises:
updating the compliance data to include the real-time corrective action;
generating a first blockchain block associated with the specific agreement of the plurality of agreements recording the real-time corrective action as a third compliance event; and
storing the first blockchain block on the distributed ledger network based on the mapping data, wherein the first blockchain block is mapped to a previous blockchain block associated with the specific agreement of the plurality of agreements on the distributed ledger network, and wherein the previous blockchain block is mapped to at least three blockchain blocks comprising at least the first blockchain block, a second blockchain block, and a third blockchain block; and
updating the previous blockchain block, wherein updating comprises recording the real-time corrective action in the previous blockchain block associated with the specific agreement of the plurality of agreements.

2. The method of claim 1, analyzing further comprising:
in response to the second smart contract executing successfully, analyzing, by the one or more processing circuits, the compliance data, wherein analyzing the compliance data comprises identifying a second real-time corrective action based on the compliance data and executing a third smart contract on the distributed ledger network.

3. The method of claim 2, further comprising:
in response to unsuccessfully identifying the second real-time corrective action, processing, by the one or more processing circuits, the compliance event, wherein processing the compliance event comprises generating a fourth blockchain block based on the compliance data and storing the fourth blockchain block on the distributed ledger network; and
sending, by the one or more processing circuits to a user computing device, a compliance event notification including the compliance data, wherein the user computing device is associated with the customer of the provider institution.

4. The method of claim 2, further comprising:
in response to successfully identifying the second real-time corrective action, executing, by the one or more processing circuits on the distributed ledger network, a fourth smart contract associated with the second real-time corrective action, wherein executing the fourth smart contract comprises updating the compliance data to include the second real-time corrective action.

5. The method of claim 4, wherein the real-time corrective action and the second real-time corrective action comprises updating, by the one or more processing circuits, the compliance data to include the real-time corrective action.

6. The method of claim 1, wherein the discrepancy is at least one of an expired compliance event, an incorrect interest rate, or a missing or incorrect signature.

7. The method of claim 6, wherein the plurality of metadata fields comprise timeline data associated with a plurality of time requirements.

8. The method of claim 6, wherein executing the second smart contract on the distributed ledger network comprises fixing the discrepancy in the compliance data.

9. The method of claim 8, wherein fixing the discrepancy further comprises:
generating, by the one or more processing circuits, the first blockchain block, the first blockchain block comprises identifying the compliance data that included the discrepancy and modifying the compliance data to fix the discrepancy; and
storing, by the one or more processing circuits, the first blockchain block on the distributed ledger network.

10. The method of claim 1, wherein the distributed ledger network contains the plurality of nodes, and wherein the one or more processing circuits is a node on the distributed ledger network, and wherein the compliance request is associated with a financial agreement between the customer and the provider institution.

11. The method of claim 1, wherein the compliance data comprises at least one of financial institution data, customer data, or agreement data, and wherein the financial institution data comprises at least one of token information, exchange histories, account balances, or verification information, and wherein the customer data comprises at least one of personal information, account number, credit card number, biometric data, social media data, geographic data, or unique identifier, and wherein the agreement data comprises at least one of a type of agreement, an agreement amount, one or more signer information, or one or more dates of signage.

12. The method of claim 1, wherein each of the first smart contract and the second smart contract comprises smart contract code, the smart contract code associated with predefined rules that when executed performs a plurality of actions on the distributed ledger network, and wherein the predefined rules are associated with a plurality of time requirements.

13. The method of claim 12, wherein the predefined rules further comprise associating one action of the plurality of actions to a plurality of real-time corrective actions on the distributed ledger network.

14. A system comprising:
at least one processing circuit configured to:
receive a compliance request for a plurality of compliance event, the compliance request comprises account information of a customer of a provider institution, and wherein each compliance event of the plurality of compliance events is a blockchain block on a distributed ledger network and comprises metadata fields for a specific agreement of a plurality of agreements with the provider institution, the metadata fields comprising at least an interest rate, an expiration date and compliance event type, and wherein each blockchain block is mapped on the distributed ledger network into sub-groupings based on a geographic location of the compliance event;
aggregate compliance data associated with the plurality of compliance event in a particular geographic region based on:
analyzing, utilizing mapping data based on the geographic location, the distributed ledger network; and
extracting the compliance data from cache of the at least one processing circuit and a plurality of nodes on the distributed ledger network based on determining the plurality of compliance events that satisfy the at least one requirement and in the particular geographic region;
analyze the compliance data, wherein analyzing the compliance data comprises:
identifying a real-time corrective action based on executing a first smart contract on the distributed ledger network, wherein identifying the real-time corrective action comprises identifying a first interest rate of a first compliance event is different than a second interest rate of a second compliance event, wherein the first compliance event is associated with a first compliance event type and the second compliance event is associated with a second compliance event type; and
identifying at least one discrepancy in the metadata fields of the compliance data of the first compliance event, wherein identifying the at least one discrepancy comprises determining the first interest rate is incorrect based on either the expiration date or a modification to the specific agreement; and
in response to successfully identifying the real-time corrective action,
automatically execute, on the distributed ledger network and in real-time, a second smart contract associated with the real-time corrective action, wherein executing the second smart contract comprises:
updating the compliance data to include the real-time corrective action;
generating a first blockchain block associated with the specific agreement of the plurality of agreements recording the real-time corrective action as a third compliance event; and
storing the first blockchain block on the distributed ledger network based on the mapping data, wherein the first blockchain block is mapped to a previous blockchain block associated with the specific agreement of the plurality of agreements on the distributed ledger network, and wherein the previous blockchain block is mapped to at least three blockchain blocks comprising at least the first blockchain block, a second blockchain block, and a third blockchain block; and
updating the previous blockchain block, wherein updating comprises recording the real-time corrective action in the previous blockchain block associated with the specific agreement of the plurality of agreements.

15. The system of claim 14, wherein the at least one processing circuit is further configured to:
in response to unsuccessfully identifying the real-time corrective action, process the compliance event, wherein processing the compliance event comprises generating a fourth blockchain block based on the compliance data and storing the fourth blockchain block on the distributed ledger network; and
send, to a user computing device, a compliance event notification including the compliance data, wherein the user computing device is associated with the customer of the provider institution.

16. The system of claim 14, wherein the discrepancy is at least one of an expired compliance event, an incorrect interest rate, or a missing or incorrect signature.

17. The system of claim 16, wherein the plurality of metadata fields comprise timeline data associated with a plurality of time requirements, and wherein executing the second smart contract on the distributed ledger network comprises fixing the discrepancy in the compliance data.

18. (canceled)

19. The system of claim 14, wherein the distributed ledger network contains the plurality of nodes, and wherein the at least one processing circuit is a node on the distributed ledger network, and wherein the compliance request is associated with a financial agreement between the customer and the provider institution.

20. One or more computer-readable storage media having instructions stored thereon that, when executed by at least one processing circuit, cause the at least one processing circuit to:
receive a compliance request for a plurality of compliance events satisfying at least one requirement, the compliance request comprises account information of a customer of a provider institution, and wherein each compliance event of the plurality of compliance events is a blockchain block on the distributed ledger network and comprises metadata fields for a specific agreement of a plurality of agreements with the provider institution, the metadata fields comprising at least an interest rate, an expiration date and compliance event type, and wherein each blockchain block is mapped on the distributed ledger network into sub-groupings based on a geographic location of the compliance event;
aggregate compliance data associated with the plurality of compliance event in a particular geographic region based on:
analyzing, utilizing mapping data based on the geographic location, the distributed ledger network; and
extracting the compliance data from cache of the one or more processing circuits and a plurality of nodes on the distributed ledger network based on determining the plurality of compliance events that satisfy the at least one requirement and in the particular geographic region;
analyze the compliance data, wherein analyzing the compliance data comprises:
identifying a real-time corrective action based on executing a first smart contract on the distributed ledger network, wherein identifying the real-time corrective action comprises identifying a first interest rate of a first compliance event is different than a second interest rate of a second compliance event, wherein the first compliance event is associated with a first compliance event type and the second compliance event is associated with a second compliance event type; and
identifying at least one discrepancy in the metadata fields of the compliance data of the first compliance event, wherein identifying the at least one discrepancy comprises determining the first interest rate is incorrect based on either the expiration date or a modification to the specific agreement; and
in response to successfully identifying the real-time corrective action, automatically execute, on the distributed ledger network and in real-time, a second smart contract associated with the corrective action, wherein executing the second smart contract comprises:
updating the compliance data to include the real-time corrective action;
generating a first blockchain block associated with the specific agreement of the plurality of agreements recording the real-time corrective action as a third compliance event; and
storing the first blockchain block on the distributed ledger network based on the mapping data, wherein the first blockchain block is mapped to a previous blockchain block associated with the specific agreement of the plurality of agreements on the distributed ledger network, and wherein the previous blockchain block is mapped to at least three blockchain blocks comprising at least the first blockchain block, a second blockchain block, and a third blockchain block; and
updating the previous blockchain block, wherein updating comprises recording the real-time corrective action in the previous blockchain block associated with the specific agreement of the plurality of agreements.
